(19) United States
(12) Patent Application Publication
(10) Pub. No.: US 2004/0126648 A1
(43) Pub. Date: Jul. 1, 2004

(54) Electrode unit and secondary battery using the same

(75) Inventors: Jun-Won Kang, Cheonan-city (KR); Su-Jin Han, Cheonan-city (KR); Chang-Seob Kim, Cheonan-city (KR); Yoon-Tai Kwak, Cheonan-city (KR); Ju-Hyung Kim, Cheongan-city (KR); Soo-Youn Maenn, Incheon-city (KR); Min-Ilo Bong, Cheonan-city (KR)

Correspondence Address: STAAS & HALSEY LLP, SUITE 700, 1201 NEW YORK AVENUE, N.W., WASHINGTON, DC, 20005, US

(73) Assignee: SAMSUNG SDI Co.,Ltd., Suwon-city (KR)

(21) Appl. No.: 10/728,892

(22) Filed: Dec. 8, 2003

(30) Foreign Application Priority Data
Dec. 28, 2002 (KR) 2002-85903

(51) Int. Cl. H01M 10/34; H01M 4/02

(52) U.S. Cl. 429/57; 429/209

(57) ABSTRACT

An electrode unit of a secondary battery prevents deviated winding of electrode plates of the electrode unit and prevents the position of an electrode tab from shifting during winding and a secondary battery having the electrode unit. The secondary battery includes an electrode unit having a first electrode plate having a first electrode uncoated portion on at least one side of a first electrode collector coated with at least a first electrode active material, a second electrode plate having a second electrode uncoated portion on at least one side of a second electrode collector coated with at least a second electrode active material, a separator interposed between the first electrode plate and the second electrode plate, and a case accommodating the electrode unit to be sealed and having a terminal portion electrically connected to the electrode unit.

### CROSS-REFERENCE TO RELATED APPLICATIONS

This application claims the priority of Korean Patent Application No.2002-85903, filed on Dec. 28, 2002, in the Korean Intellectual Property Office, the disclosure of which is incorporated herein in its entirety by reference.

### BACKGROUND OF THE INVENTION

1. Field of the Invention

The present invention relates to a secondary battery, and more particularly, an electrode unit in which a positive electrode plate, a negative electrode plate and a separator interposed therebetween, are wound, and a secondary battery using the same.

2. Description of the Related Art

With rapid advancement of lightweight, wireless electronic devices such as mobile phones, camcorders, notebook type computers and the like, development of lithium ion batteries having a high-energy density power supply of such electric devices is being actively conducted. A secondary battery is formed by accommodating a circular or noncircular spiral electrode unit in a circular or rectangular can or pouch.

In such a secondary battery, an electrode unit is spirally wound in a state in which a positive electrode strip is coated with a positive electrode active material, except a portion of either end of a strip-like positive electrode collector (referred to as a positive electrode uncoated portion), a negative electrode strip is coated with a negative electrode active material, except a portion of either end of a strip-like negative electrode collector (referred to as a negative electrode uncoated portion), and a separator is interposed between the positive electrode strip and the negative electrode strip. A lead is installed at either the positive electrode uncoated portion or the negative electrode uncoated portion.

Since the uncoated portions are formed of thin films, a deviation may occur between the negative and the positive electrode uncoated portions during an initial winding stage, resulting in poor efficiency of winding. In particular, since a lead is installed at the negative electrode uncoated portion, the lead may be shifted from its original location.

U.S. Pat. No. 5,508,122 discloses a battery having a spiral electrode unit. The disclosed electrode unit is configured such that the same polarities are positioned at both sides of exposed areas of a negative electrode strip made of a core material and separated via a separator.

Japanese Patent Publication No. hei 11-111327 discloses a battery having a spiral electrode unit in which a negative electrode plate is positioned at the innermost winding part of the electrode unit, and a positive electrode plate made of a copper foil is positioned at the outermost winding part.

As described above, in the conventional spiral electrode units, although exposed regions of positive and negative electrodes, that is, uncoated portions, are described, the problem of deviated winding is still unresolved.

### SUMMARY OF THE INVENTION

Accordingly, the invention provides an electrode unit of a secondary battery which solves the problem of deviated winding of electrode plates of the electrode unit and prevents the position of an electrode tab from shifting during winding, and a secondary battery having the electrode unit.

In accordance with an aspect of the present invention, an electrode unit comprises a first electrode plate having a first electrode uncoated portion on at least one side of a first electrode collector coated with at least a first electrode active material, a second electrode plate having a second electrode uncoated portion on at least one side of a second electrode collector coated with at least a second electrode active material, and a separator interposed between the first electrode plate and the second electrode plate; wherein a folded portion is provided on at least one edge of the first electrode and the second electrode plate so that portions of a same electrode plate face each other.

The folded portion may be provided at the uncoated portion of either electrode plate.

Also, the folded portion may be provided at a winding start portion of either electrode plate.

The folded portion is generally folded such that a burr portion at an edge of either electrode collector contacts the same polarity.

The folded portion of the second electrode plate may be positioned at one side of at least a portion of the first electrode plate where the first electrode tab is disposed, in a state in which the separator is interposed between the folded portion and the first electrode plate. In this case, the electrode unit may further comprise an insulating tape attached to a portion of the second electrode plate corresponding to the first electrode tab of the first electrode plate.

The length of the second electrode uncoated portion positioned at the innermost part of the electrode unit is typically 5 to 15 mm.

In accordance with another aspect of the present invention, a secondary battery comprises an electrode unit having a first electrode plate having a first electrode uncoated portion on at least one side of a first electrode collector coated with at least a first electrode active material, a second electrode plate having a second electrode uncoated portion on at least one side of a second electrode collector coated with at least a second electrode active material, a separator interposed between the first electrode plate and the second electrode plate, and a case accommodating the electrode unit to be sealed and having a terminal portion electrically connected to the electrode unit.

In the secondary battery, the folded portion may be located at the uncoated portion of either electrode plate. Also, the folded portion may be located at a winding start portion of either electrode plate. The folded portion is generally folded such that a burr portion at an edge of either electrode collector contacts the same polarity.

Also, the folded portion of the second electrode plate may be located at one side of at least a portion of the first electrode plate where the first electrode tab is disposed, in a state in which the separator is interposed between the folded portion and the first electrode plate. In this case, the electrode unit may further comprise an insulating tape attached to a portion of the second electrode plate corresponding to the first electrode tab of the first electrode plate. Here, the length of the second electrode uncoated portion positioned at the innermost part of the electrode unit is generally 5 to 15 mm.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a secondary battery according to an embodiment of the present invention;

FIG. 2 is a cross-sectional view illustrating a winding state of an electrode unit of the secondary battery according to an embodiment of the present invention; and

FIG. 3 is a cross-sectional view illustrating a folded portion shown in FIG. 2 in greater detail.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

An embodiment of the present invention will now be described in detail with reference to the accompanying drawings.

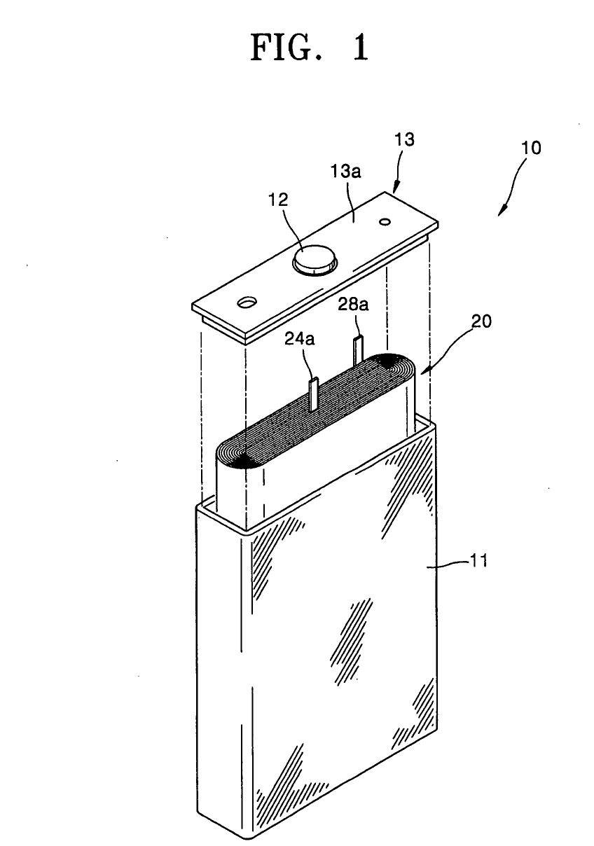

FIG. 1 shows an exemplary rechargeable secondary battery according to an embodiment of the present invention.

Referring to FIG. 1, a secondary battery 10 includes a case 11 having a sealed space, an electrode unit 20 inserted into the space of the case 11, and a cap plate 13a sealing the space having the electrode unit 20 inserted thereinto.

As shown in FIG. 1, the case 11 is generally substantially rectangular and may serve as a terminal. In an embodiment of the present invention, the case may be made of a light, conductive metal such as Al or an Al alloy. Also, the case has an opening at one plane, and the electrode unit 20 is accommodated inside the case 11 through the opening. As shown in FIG. 1, the case 11 may be rectangular shaped with angled edges at lateral sides. Also, although not shown, the edges may be round.

The cap assembly 13 is sealed with the case 11. The cap assembly 13 includes a cap plate 13a directly welded to the opening for sealing. The case 11 and the cap plate 13a may be formed of the same metal for increasing weldability.

A terminal pin 12 is formed in the cap assembly 13 to penetrate the cap plate 13a via a gasket (not shown), and an insulating plate and a terminal plate (not shown) are further formed under the terminal pin 12 so that the terminal pin 12 is insulated from the cap plate 13a. A first electrode tab 24a drawn out from a first electrode plate of the electrode unit 20 is welded to the lower portion of the terminal pin 12, functioning as a first electrode terminal. A second electrode tab 28a drawn out from a second electrode plate of the electrode unit 20 is directly electrically connected to the bottom surface of the cap plate 13a or to the internal surface of the case 11, so that the outer portion of the battery except the terminal pin 12 may function as a second electrode terminal. However, structures of the first and second electrode terminals are not limited to those described above. That is, the second electrode terminal may be formed using a separate terminal pin, like the first electrode terminal, and other suitable structures may be employed.

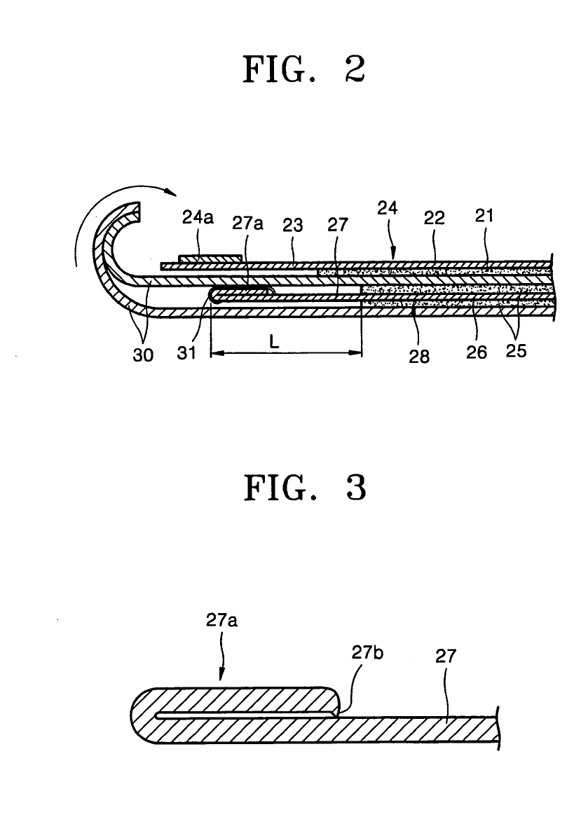

The electrode unit 20 is formed of a first electrode plate 24, a second electrode plate 28 and a separator 30 interposed therebetween, as shown in FIG. 2. That is, according to an embodiment of the present invention, a jelly-roll type electrode unit 20 has the first and second electrode plates 24 and 28 and the separator 30 interposed therebetween, laminated and wound.

Generally, the first electrode plate 24 may also be used as a negative electrode plate. The first electrode plate 24 that may be used as a negative electrode plate includes a first electrode collector 22 made of a strip-like, metal foil. As the first electrode collector 22, a copper foil may be used. A first electrode coated portion 21 coated with a first electrode compound material containing a first electrode active material is formed on at least one side of the first electrode collector 22. A carbon material may be used as the first electrode active material. The first electrode compound material may include a binder, a plasticizer, a conductive material and the like.

The second electrode plate 28 that may be used as a positive plate includes a second electrode collector 26 made of a strip-like, metal foil. As the second electrode collector 26, an aluminum foil may be used. A second electrode coated portion 25 coated with a second electrode compound material containing a second electrode active material is formed on at least one side of the second electrode collector 26. A lithium oxide may be used as the second electrode active material. The second electrode compound material may include a binder, a plasticizer, a conductive material and the like.

FIG. 2 shows a central portion of a winding of the first and second electrode plates 24 and 28, in which a first electrode uncoated portion 23 and a second electrode collector 26, respectively, are formed. The first electrode tab 24a is welded to the first electrode uncoated portion 23 that is positioned at the central portion of the winding. A nickel film may be used as the first electrode tab 24a. Also, an aluminum film may be used as the second electrode tab 28a. As shown in FIG. 1, the second electrode tab 28a may be positioned at the outermost part of the electrode unit 20. Of course, the second electrode tab 28a may also be positioned at the second electrode uncoated portion in the central portion of the winding, like the first electrode tab 24a.

Here, a folded portion is located on at least one of the first electrode uncoated portion 23 and the second electrode uncoated portion 27 positioned at the innermost part of the electrode unit 20 and spirally wound, the folded portion being folded to have portions of a same electrode plate face each other. Generally, the folded portion 27a is formed at the second electrode uncoated portion 27 that serves as a positive electrode, as shown in FIG. 2.

The folded portion 27a allows the second electrode plate 27 to be inserted effectively into a mandrel for winding. The winding-type electrode unit is generally wound using a winding mandrel rotating at high speed. However, when a common electrode plate is inserted into such a winding mandrel, effective insertion may not be performed, resulting in poor winding efficiency. Thus, the folded portion 27a is separately provided to facilitate insertion of the leading edge of a wound electrode plate.

Also, the folded portion 27a may prevent an occurrence of a short-circuit between electrodes due to burring. As shown in FIG. 3, a burr portion 27b is formed at a cut edge of the second electrode collector 27 formed by a general manufacturing method of the electrode plates. The burr portion 27b may tear the separator positioned in the vicinity thereof to then be connected to an electrode plate having the opposite polarity, causing an internal short-circuit. In order to prevent an internal short-circuit, an embodiment of the present invention provides the folded portion 27a to make the burr portion 27b face the second electrode uncoated portion 27, that is, to make the burr portion 27b not face outward with respect to the second electrode uncoated portion 27.

The folded portion 27a may further include an insulating tape 31 at outer surface of the second electrode collector 27.

During the winding of the first electrode plate 24 and the second electrode plate 28, an end of the folded portion 27a formed at the second electrode uncoated portion 27 may overlie a portion where the first electrode tab 24a of the first electrode plate 24 is located, in a state in which the separator 30 is disposed between the first electrode tab 24a and the folded portion 27a. To this end, the second electrode uncoated portion 27 may be 5 to 15 mm in length (L). In this case, the first electrode plate 24 and the second electrode plate 28 may be insulated from each other at the overlying portion by the insulating tape 31 attached to the outer surface of the folded portion 27a.

The above-described folded portion may also be provided at the first electrode uncoated portion 23 of the first electrode plate 24.

In the secondary battery according to an embodiment of the present invention, as described above, since a folded portion is formed on at least one of a first electrode uncoated portion and a second electrode uncoated portion positioned at the innermost part of an electrode unit accommodated inside a case of the battery, deviated winding or loose portion may be avoided during winding of the electrode unit. In particular, since a mandrel for winding an electrode unit securely places the first electrode uncoated portion and/or the second electrode uncoated portion, the winding speed may be increased and manufacturability is enhanced accordingly. Also, since an insulating tape is further provided, insulation between the positive electrode uncoated portion and the negative electrode uncoated portion may be made with increased reliability.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. An electrode unit comprising:
a first electrode plate having a first electrode uncoated portion on at least one side of a first electrode collector coated with at least a first electrode active material;
a second electrode plate having a second electrode uncoated portion on at least one side of a second electrode collector coated with at least a second electrode active material; and
a separator interposed between the first electrode plate and the second electrode plate,
wherein a folded portion is provided on at least one edge of the first electrode plate and the second electrode plate to have portions of a same electrode plate face each other.

2. The electrode unit of claim 1, wherein the folded portion has an insulating tape attached thereto.

3. The electrode unit of claim 1, wherein the folded portion is provided at the uncoated portion of either the first or the second electrode plate.

4. The electrode unit of claim 1, wherein the folded portion is provided at a winding start portion of either the first or the second electrode plate.

5. The electrode unit of claim 1, wherein the folded portion is folded such that a burr portion at an edge of either the first or the second electrode collector contacts a same polarity.

6. The electrode unit of claim 1, wherein the folded portion of the second electrode plate is positioned at one side of at least a portion of the first electrode plate where the first electrode tab is disposed, wherein the separator is interposed between the folded portion and the first electrode plate.

7. The electrode unit of claim 6, further comprising an insulating tape attached to a portion of the second electrode plate corresponding to the first electrode tab of the first electrode plate.

8. The electrode unit of claim 1, wherein a length of the second electrode uncoated portion positioned at the innermost part of the electrode unit is 5 to 15 mm.

9. A secondary battery comprising:
an electrode unit having a first electrode plate having a first electrode uncoated portion on at least one side of a first electrode collector coated with at least a first electrode active material, a second electrode plate having a second electrode uncoated portion on at least one side of a second electrode collector coated with at least a second electrode active material, and a separator interposed between the first electrode plate and the second electrode plate; and
a case accommodating the electrode unit to be sealed, and having a terminal portion electrically connected to the electrode unit.

10. The secondary battery of claim 9, wherein a folded portion is provided at the uncoated portion of either the first or the second electrode plate.

11. The secondary battery of claim 10, wherein the folded portion is provided at a winding start portion of either the first or the second electrode plate.

12. The secondary battery of claim 10, wherein the folded portion is folded such that a burr portion at an edge of either the first or the second electrode collector contacts a same polarity.

13. The secondary battery of claim 10, wherein the folded portion of the second electrode plate is positioned at one side of at least a portion of the first electrode plate where the first electrode tab is disposed, wherein the separator is interposed between the folded portion and the first electrode plate.

14. The secondary battery of claim 13, further comprising an insulating tape attached to a portion of the second electrode plate corresponding to the first electrode tab of the first electrode plate.

15. The secondary battery of claim 9, wherein a length of the second electrode uncoated portion positioned at the innermost part of the electrode unit is 5 to 15 mm.

16. The secondary battery of claim 10, wherein the folded portion has an insulating tape attached thereto.

17. The electrode unit of claim 1, wherein the first electrode plate is a negative electrode plate having a first electrode collector comprising a metal foil.

18. The secondary battery of claim 9, wherein the first electrode plate is a negative electrode plate having a first electrode collector comprising a metal foil.

19. The electrode unit of claim 1, wherein the first electrode active material comprises a carbon material.

20. The secondary battery of claim 9, wherein the first electrode active material comprises a carbon material.
